(19) United States
(12) Patent Application Publication
(10) Pub. No.: US 2002/0184164 A1
(43) Pub. Date: Dec. 5, 2002

(54) Method and apparatus for enhancing the productivity of mail processing equipment

(75) Inventor: Douglas B. Quine, Bethel, CT (US)

Correspondence Address: Pitney Bowes Inc., Intellectual Property and Technology Law Depart., P.O. Box 3000, 35 Waterview Drive, Shelton, CT, 06484, US

(73) Assignee: Pitney Bowes Incorporated, Stamford, CT (US)

(21) Appl. No.: 09/871,335

(22) Filed: May 31, 2001

(51) Int. Cl. G06F 17/60; G06F 17/00; G07B 17/02

(52) U.S. Cl. 705/401

(57) ABSTRACT

An apparatus and method for enhancing the productivity of mail processing equipment by forwarding monitored information to a processor system, and proactively generating recommendations to prevent equipment breakdown and system performance by comparing the monitored information with preventative maintenance information and business rules stored in a local or remote processor system. The proactive recommendations not only provide customers with preventative maintenance information, but also information regarding better processes and elimination of business practices that are observed to be potentially problematic. Further, cost-benefit recommendations, and recommendations identifying new customers may also be forwarded to the operator or management as part of the feedback recommendations. These generated recommendations are conveyed to customers responsible for the mailings in order to initiate preventative measures, cost savings, and benefit from improved marketing opportunities.

### FIELD OF THE INVENTION

This invention relates to mail processing systems. More particularly, it relates to a method and apparatus for enhancing the productivity of mail processing equipment

### BACKGROUND AND SUMMARY OF THE INVENTION

A number of vendors offer equipment for the processing mail in order to present the mail to postal authorities and other companies (delivery companies) engaged in like business. These companies require that mail-handling equipment meet their processing and documentation standards. Handling of paper materials/documents by the mail processing equipment is difficult due to the precise physical attributes of the paper that are affected by humidity, temperature, creasing, and differences in paper types. Mail handling equipment thus requires considerable and periodic adjustments in setup, and maintenance to achieve enhanced productivity. Delivery companies also require that detailed rules and regulations be followed to ensure that the received mail is ready for further processing in order to justify the work sharing discounts offered by the delivery companies to their customers (mailers).

Current mail processing equipment fails to provide feedback information relating to the value of the task that is currently being performed because the mail processing equipment performs its task irrespective of benefits or detriments to an enterprise' objectives. Also, different materials used for manufacturing mailed documents cause mail processing equipment to wear and thus respond inconsistently. For example, highly abrasive packaging materials may cause certain parts of the equipment to wear faster. Also, operator error or misunderstandings may cause certain components to wear prematurely and cause equipment failure. Lack of preventative maintenance such as, for example, lubrication, cleaning, and replenishing of consumables may cause the equipment to perform below design specifications. Further, the mail processing equipment fails to offer feedback to an operator or management personnel regarding the interactions between the equipment and the operator regarding the internal working conditions of the equipment.

In addition to the above, processing of mail, for instance, letters being presented to the United States Postal Service, requires mailers follow very detailed specifications which are defined in the Domestic Mail Manual. The postage rates (costs to mailer) and earned discounts (savings to the mailer) are based upon the letter weight, the degree to which letters are bundled together by destination (presort), the selected delivery service (Express, First Class, Standard Class), and the automation tools provided by the USPS (prebarcoding). If first class letters weigh more than one ounce, the current cost of mailing being $0.34, then additional ounces (current charge being $0.21 rate each) must be paid. For instance, if a credit card bill is being mailed with additional advertising inserts with a total weight per mail piece of 1.01 ounces, the postage cost is $0.55 with an incremental cost of $0.21 for the final 0.01 ounce. This is an effective postage rate of $21 per ounce for the final additional direct mail advertising materials that are inserted. These additional materials could have been left out, or in the alternate the credit card bill may have been augmented with additional advertising materials up to 1.99 ounces with no additional postage cost. The present invention provides a solution to overcome this problem.

Accordingly, there is a need to overcome the problems identified by the prior art. The present invention, thus proposes a solution wherein the tasks performed by the mail processing equipment coincide with the objectives of an enterprise. Further, the present invention offers feedback information to an operator or management personnel regarding the internal working conditions of mail processing equipment in order to provide preventative maintenance or user training recommendations.

The present invention is directed to an apparatus for enhancing the productivity of mail processing equipment by forwarding monitored information to a processor system. The monitored information may include, such information as, for example, preventative maintenance information. The apparatus proactively generates and forwards recommendations to prevent equipment breakdown by comparing the monitored information with reference values that are stored in the processor system. The proactive recommendations not only provide customers with preventative maintenance information, but also provide information regarding better processes, and elimination of business practices that are observed to be potentially problematic. The proactive generation of recommendations may be performed in real-time, or in the alternate may be performed periodically. The generated recommendations are then conveyed to the mailer's representative in order to initiate preventative or maintenance measures. The proactive recommendations offered by the present invention thus overcome the prior art problems and provide for efficiently handling the mail documents.

In another embodiment, the present invention is directed to an apparatus for enhancing the productivity of mail processing equipment by forwarding information related to mail documents, the information including, for example, weights of the documents, and the distribution of destination address to which the object is mailed. The monitored document parameters are compared with reference values in a computer system, and recommendations are proactively generated to maximize cost savings to the customer. The apparatus may also perform customer profile analysis to generate new customers from a demographic area by comparing destination customer profile information from the computer system with available respective demographic databases.

In one aspect, the present invention provides an apparatus for improving the productivity of mail processing equipment, comprising a processor system communicatively coupled to the mail processing equipment, the processor system receiving information from the mail processing equipment to proactively generate feedback information, and a communication device coupled to the processor system for communicating feedback information to at least a local operator or a remote user. The processor system further comprises a memory for storing known sets of mail related data, a comparator for comparing the received data with data stored in the memory to determine deviations from the stored data.

In another aspect, in an apparatus including a processor system having a memory device, a method of enhancing the productivity of mail processing equipment, comprising monitoring at least one parameter related to the mail processing equipment, communicating the monitored parameter to the processor system, comparing the monitored parameter with reference data to proactively generate an output signal, the signal representing deviation of the monitored data from the reference data, and communicating the proactively generated signal to a local operator or a remote user.

In yet another aspect, the present invention provides an apparatus for enhancing the productivity of mail processing equipment having means for receiving information from the mail processing equipment, a processor means for storing reference data; a comparison means for comparing the received information with reference data and generating a feedback signal proportion to the comparison; and a communication means for communicating the feedback signal to a local operator or a remote user.

It will thus be seen that according to the present invention, an apparatus for improving the productivity of mail processing equipment by proactively generating feedback information is described to overcome the problems faced by the prior art. The feedback information provided to customers may either be provided on a real-time basis, or periodically. While the invention has been herein shown and described in what is presently conceived to be the most practical and preferred embodiment, it will be apparent to those of ordinary skill in the art that many modifications may be made thereof within the scope of the invention, which scope is to be accorded the broadest interpretation of the appended claims so as to encompass all equivalent methods and apparatus.

### BRIEF DESCRIPTION OF THE DRAWINGS

FIG. 1 is an exemplary schematic of the present invention;

FIG. 2 illustrates a detailed schematic of the present invention as identified in FIG. 1.

FIG. 3 illustratrates a process flow chart for performing preventative maintenance tracking and obtaining feedback in accordance with the present invention;

FIG. 4 illustrates an exemplary flow chart for broader usage of the present invention beyond performing preventative maintenance activities as shown in FIG. 2;

FIG. 5 illustrates another embodiment of the present invention, specifically illustrating an exemplary flow chart for capturing information about the mailing, transferring the data to an analysis platform, and providing recommendations to the mailer.

### DETAILED DESCRIPTION OF THE INVENTION

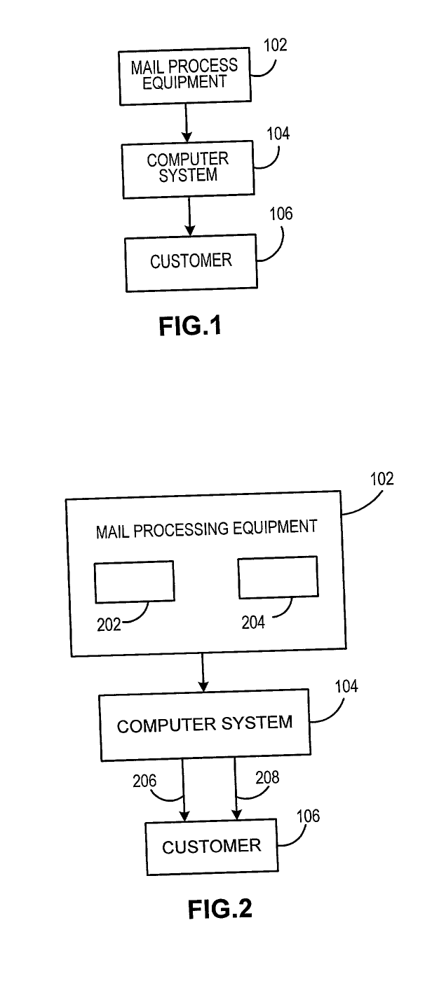

Referring now to FIG. 1, there is shown an exemplary schematic of the mail processing apparatus as indicated at 100 of the present invention. For the discussion related to the present invention, “object data” or “document data” is defined to include information about a document that is mailed. Such information may include, for example, the weight of the document, the delivering option, the postage rate, the destination address, and the like. “System data” is defined to represent data related to the conditions of the mail processing equipment. Such information may include, for example, wear and tear of system parts, the system throughput, the efficiency at which the system is operating, the operating conditions of the system, such as operating temperature, pressure, and the like.

Still referring to FIG. 1, mail-processing equipment/system 102 monitors information about mail documents and forwards monitored information to a computer system 104. The computer system 104 may be embedded in the mail processing system (i.e., situated locally), or remote from the mail processing equipment 104. Computer system 104 may include a database, the database having such information as, for example, business rules, postal rates, best practice guidelines such as typical presort rates, typical postage rates, and recommendations based on different operating conditions. The database may be populated with such information as, for example, 1 ounce=$0.34, 2 ounces=$0.55, 3 ounces=$0.76, 4 ounces=$0.97, and the like. The database may also be populated with business rules, such as, for example, weight above 0.5 ounce fraction=good; weight between 0.2 and 0.5 fraction=recommend more inserts; weight between 0.01 and 0.19 fraction=recommend weight reduction or recommend adding more inserts. Information monitored by the mail processing equipment 102 is compared with corresponding reference values stored in the computer system 104 in order to generate recommendations to a user. The recommendations are then conveyed to the customer 106 responsible for the mailings. The responsible parties may include, for example, the system operator, the actual mailer/customer, the mailroom manager, or an outsourcing organization for mailroom operations.

Referring now to FIG. 2, there is shown a detailed schematic of the mail processing apparatus of the present invention as identified in FIG. 1. The mail processing system 102 may include various parameter sensors 202 such as, for example, pressure sensors, humidity sensors, temperature sensors, weight sensors, that monitor respective parameter information 204, such as, for example, destination postal code, from documents that are mailed by a user. Information collected by the parameter sensors 202 is communicated to the computer system 104 for further processing. Information from parameter sensors 202 may be sent to the computer system 104 via wireline or wireless communication systems. A packet switching network, such as, for example, an Internet may also be used for communicating such information. Further, the computer system 104 may be located either locally, for example, within 102 in close proximity to the mail processing system 102, or remote from the mail processing equipment 102. Although standard communication protocols are used for communication purposes, the present invention should be construed to cover all available communication protocols, while not deviating from the spirit and scope of the invention.

Still referring to FIG. 2, the computer system 104 may be configured with stored data which includes, for example, preventative maintenance schedule calender and preventative maintenance warning dates for the mail processing system 102. The computer system 104 may further include information related to business rules for mail processing, and demographic and customer lists. As noted above, information gathered by the mail processing system 102 is compared with the reference information stored in the computer system 104. In the event of identifying any deviations from the reference values, the computer system 104 outputs a trigger to an operator as indicated at 106, the trigger informing the operator that preventative maintenance to mailprocessing system 102 may be necessary. The trigger to the operator may be in the form of, for example, a visual display indicating a warning signal, an e-mail message via link 206, a page, a telephone call, or the like via link 208.

In the event of a failure to perform preventative maintenance on the mailprocessing system 102, further warning indicators may be initiated indicating that the preventative maintenance schedule has not been met, and that the system 102 is overdue for maintenance. The warning indicators/triggers may also be addressed to escalating levels of individuals of an organization.

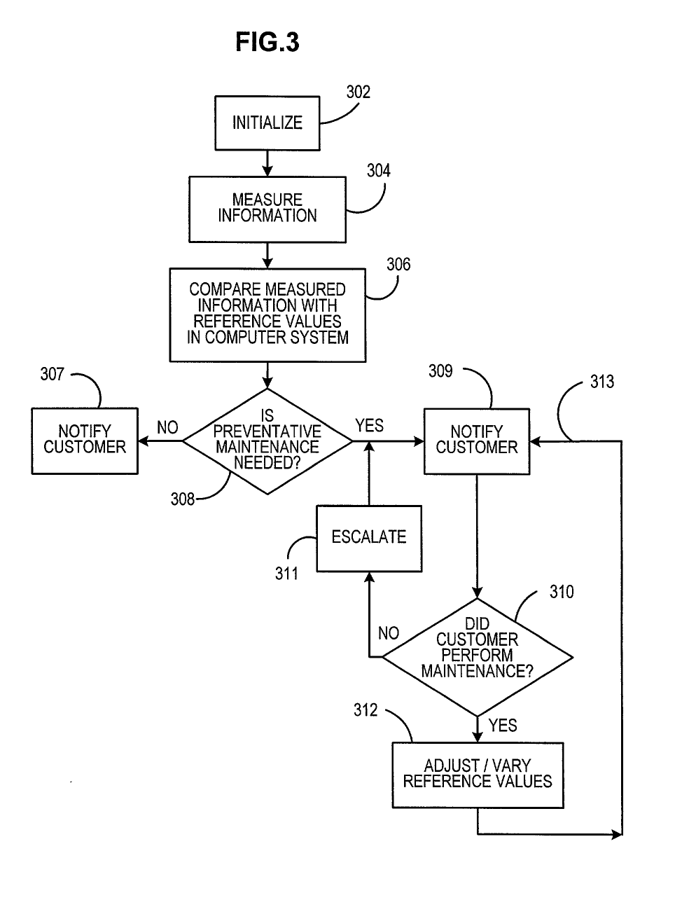

FIG. 3 shows an exemplary process flow chart for performing preventative maintenance tracking, and obtaining feedback information in accordance with the present invention. The preventative maintenance process is initialized as indicated at 302. Once the process is initialized, document information is gathered by sensors 202 (FIG. 2) at step 304. The gathered information is compared with reference information stored in computer system 104 (FIG. 1) during step 306. If preventative maintenance is determined to be needed at step 308, then the customer is notified during step 309 that such preventative maintenance is required. This notification may be, for example, in the form of a e-mail message, a visual display indicating a warning signal, page, facsimile, and the like.

Once the customer is notified during step 309, during step 310 it is verified whether or not such preventative maintenance has been performed by the customer. If it is determined that the preventative maintenance is not performed by the customer after an appropriate interval during step 310, then notification about preventative maintenance is escalated in priority during step 311 and delivered to the customer or service management personnel. However, if the preventative maintenance is determined to be not needed, then such information is fed back to the customer via notification as identified in step 309. If it is determined that the mail processing equipment requires preventative maintenance and the customer did perform preventative maintenance further to notification as in step 309, the service organization may wish to reschedule maintenance of system 102 as indicated at step 312. Such maintenance rescheduling may be necessary depending on the environment in which the system 102 operates, such as, for example, heavy use, harsh environment. The service organization or an operator may also add data to system 102 in order to identify specific parts of system 102 (FIG. 1) that are subject to excessive wear. This could include information about parts being replaced. Such system parts may include, for example, parts receiving excessive wear and tear, parts requiring special attention due to use pattern, parts disposed in a harsh machine environment, parts that are subject to excessive use by operator(s), etc. This adjusted information is fed back via loop 313 to the customer as identified during step 309.

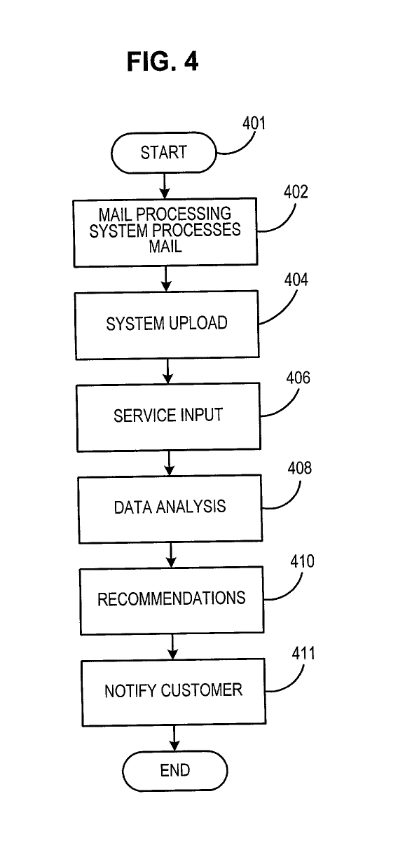

FIG. 4 shows another embodiment where the mail processing system related information (system data) gathered by system 102 is compared to the reference values stored in computer system 104. The resulting data may be uploaded at step 404 to a remote site for data analysis as indicated at step 408. The analyzed data may be fed back to a customer's site or notfied to the customer as indicated at step 411 with recommendations to adopt efficient processes and eliminating business methods that may be causing problems to system 102 (FIG. 1) in order to improve the productivity and reduce maintenance costs.

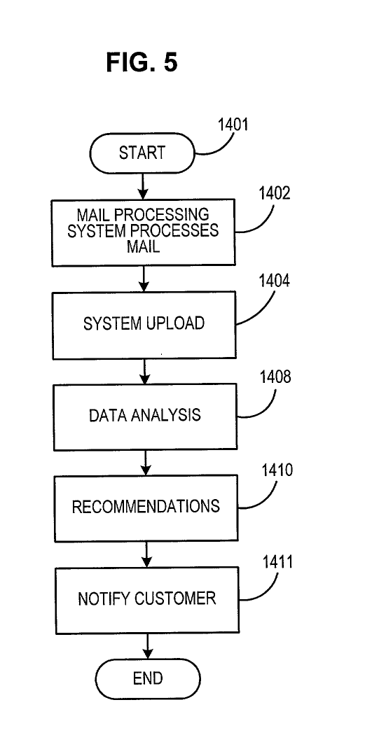

Referring now to FIG. 5, there is shown another embodiment of the present invention wherein elements in common with FIG. 4 are identified with like reference numerals but with a prefix “1” added. Here, the object related information such as, for example, object dimensions, weight, destination postal code, etc. are measured during step 1402. The measured data may be uploaded at step 1404 to a remote site for data analysis as indicated at step 1408. The data analysis is conducted by comparing the measured data to reference values stored in the computer system 104 (FIG. 1). The recommendations generated at step 1410 are fed back to a customer's site or notified to the customer as indicated at step 1411 to improve the productivity of the mail processing system 102 (FIG. 1). The recommendations may include, for instance, if the weight of a object is 1.01 ounces, then the object's weight need to be reduced to 0.99 ounces by eliminating a portion of the object which is not worth the postage rate increase, or adding additional marketing materials to bring the weight of the object closer to 1.99 ounces, thus justifying the postage rate increase.

The data analysis conducted during step 1408 also includes comparing the customer data, gathered during step 1402, with demographic information for a particular geographic area. Comparison of customer profiles with profiles of people from similar geographic area would be an efficient method to identify potential customers, and thus an efficient way to built a business. In this fashion, the mail processing system actually becomes a system that would faciliate to build new customers with simplicity.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A mail processing system, comprising:
a plurality of sensors coupled to the mail processing system for collecting system data;
a plurality of computer input means, said computer input means capable of receiving input information;
a processor system communicatively coupled to the mail processing system, the processor system receiving said system data and generating feedback signals; and
a communication system coupled to said processor system for communicating said feedback signals to at least a local user or a remote user.

2. The apparatus of claim 1 wherein said processor system further comprises:
a database for storing predetermined sets of system data; and
a comparator for comparing the system data received from said sensors with the predetermined sets of system data to generate feedback signals.

3. The apparatus of claim 1, wherein said communication system is a wireline communication system.

4. The apparatus of claim 1, wherein said communication system is a wireless communication system.

5. The apparatus of claim 2, wherein said system data comprising preventative maintenance schedules, and performance statistics.

6. The apparatus of claim 2, wherein the system data stored in said processor system is variable.

7. The apparatus of claim 2, wherein said feedback signals include improvement recommendations.

8. A mail processing system, comprising:
a plurality of sensors for measuring object data and system data;
a computer system communicatively coupled to said mail processing system, the computer system receiving said object data and said system data, said computer system further comprising:
a database system for storing predetermined sets of object data and system data, respectively;
a comparator for comparing the measured object data and system data with predetermined sets of object data and system data, respectively, and proactively generating feedback signals in the event of a mismatch in the comparison step; and
a communication system coupled to said computer system for communicating the feedback signals to at least one of a remote user or a local user.

9. The apparatus of claim 8, wherein said communication system is a wireline communication system.

10. The apparatus of claim 8, wherein said communication system is a wireless communication system.

11. The apparatus of claim 8, wherein said system data comprises data related to preventative maintenance schedules, and performance statistics.

12. The apparatus of claim 8, wherein said object data comprises data related to business rules, postal rates, and customer profiles.

13. The apparatus of claim 8, wherein the system data stored in said processor system is variable.

14. The apparatus of claim 8, wherein said feedback signals include improvement recommendations.

15. The apparatus of claim 8, wherein said feedback signals include cost savings information.

16. A method of proactively performing mail processing functions in a mail processing system, the method comprising:
monitoring at least one parameter related to said mail processing system;
receiving the monitored parameter by a computer system;
comparing the monitored parameter with a reference value to determine a mismatch in said comparison step;
triggering an output signal in the event of a mismatch; and
communicating said output signal to at least one of a local user or a remote user.

17. The method of claim 16, wherein:
the reference value is stored in a database system.

18. The method of claim 17, wherein said database system is located within said computer system.

19. The method of claim 17, wherein said database system is located remote from said computer system.

20. The method of claim 16, wherein said communication step is performed using a wireline communication system.

21. The method of claim 16, wherein said communication step is performed using a wireless communication system.

22. The method of claim 16, further comprises:
monitoring at least one parameter related to mail objects processed by said mail processing system; and
monitoring at least one parameter related to said mail processing system.

23. The method of claim 22, wherein parameters related to mail processing system comprises preventative maintenance schedules, and performance statistics.

24. The method of claim 22, wherein parameters related to mail objects comprise business rules, postal rates, and customer profiles.

25. The method of claim 16, wherein:
said reference values stored in said database comprise predetermined mail processing system values and predetermined mail object values, respectively.

26. The method of claim 25, further comprises:
varying said reference values stored in said database system.

27. The method of claim 16, wherein said feedback signals include improvement recommendations.

28. The method of claim 16, wherein said feedback signals include cost savings information.
